(19) United States
(12) Patent Application Publication
(10) Pub. No.: US 2006/0292316 A1
(43) Pub. Date: Dec. 28, 2006

(54) Profile correction for RFID label with transponder

(76) Inventors: Kevin Conwell, Fairfield, OH (US); Matt Adams, Mason, OH (US)

Correspondence Address: Orum & Roth LLC, Ste 1616, 53 W Jackson Blvd, Chicago, IL, 60604, US

(21) Appl. No.: 11/365,981

(22) Filed: Mar. 1, 2006

Related U.S. Application Data
(60) Provisional application No. 60/658,058, filed on Mar. 1, 2005.

(51) Int. Cl. B41M 5/00

(52) U.S. Cl. 428/32.1

(57) ABSTRACT

A smart label construction that provides a more uniform profile for improved print performance in a thermal label printer. The preferred label design has a layer of pressure sensitive piece of applied over the inlay and beyond the edges of the inlay to provide a smoother step transition and eliminates printing voids along the inlay edges. An oversized adhesive patch is applied at the insert. The adhesive patch extends beyond the perimeter edges of the inlay masking the thickness transition of the inlay base film. Alternatively, a coat of additional adhesive is applied only on the leading and trailing edges of the transponder. Alternatively, a low viscosity adhesive is applied to the backside of the inlay prior to singulating the inlay and inserting it into the label stock. The low viscosity adhesive flows beyond the perimeter of the transponder and fills voids. Alternativley, transponder may compress into a low viscosity of adhesive on the label substrate.

This application claims the benefits of U.S. Provisional Application No. 60/658058 filed 1 Mar. 2005 entitled Profile of [sic] Correction for RFID Label with Transponder.

### BACKGROUND OF THE INVENTION

1. Field in the Invention

The present invention relates to RFID smart labels. More particularly it relates to an RFID smart label with the uniform printable surface for thermal printing.

2. Description of Related Art

Radio frequency transponders (also known as RFID tags) generally include an antenna and integrated memory circuit with read/write capability used to store additional information, such as electrically erasable programmable read only memory (EEPROM) or similar electronic information. Active RFID tags include their own radio transceiver and power source, such- as a battery, and are generally sealed within a plastic housing or button. Passive RFID tags are energized to transmit or receive data by an electromagnetic field and do not include a radio transceiver or power source. As a result, they are smaller, but they also have a limited range, resolution and data storage capacity.

Passive RFID tags are used in the automatic identification industry and are typically laminated to label stock or inserted into a label. The label is typically backed with pressure sensitive adhesive for applying the printed label to a carton, palette, baggage or luggage, parcel or other article to be tracked. A common transponder inlay design uses a direct chip attachment on a flexible antenna base film substrate known as flip-chip-on-flex (FCOF). Anistropic conductive adhesive is applied under the application-specific integrated circuit (ASIC or IC) connecting it to the antenna trace.

The insertion of an RFID transponder into a pressure sense of label causes a change in the profile of the label in the vicinity of the transponder. This change in profile causes problems when printed with a thermal printer. When the thermal print head encounters the RFID transponder, the pressure exerted by the print head increases in the region of the transponder and greatly decreases in the area immediately adjacent to the transponder inlay, which is in the entire perimeter of the antenna base film. This lack of contact and pressure along the inlay permits or results in print voids, as shown in FIG. 1, due to the non-uniform label surface profile. This dropout imprint around the inlay becomes more severe with a thicker transponder base film.

The print voids along me inlay edges of prior art smart label limits the performance of the labels. It also limits where the transponder inlay can be a place within the label. For example, a customer is unable to print a ladder bar code across an inlay without losing a narrow element of the barcode. There is a need for a printable RFID smart label with a uniform printable surface which can be printed on without print voids.

Additionally, smart labels are often used for security or anti-counterfeiting measures. In those situations is undesirable to have a detectable transponder. If the transponder is detectable, the ability of the label to covertly operate is compromised. Print voids are a visible indication of an transponder. Thus, there is a need for printable RFID smart label that can be printed without print voids to reduce risk of transponder detection.

### SUMMARY OF THE INVENTION

The inventive smart label construction provides a more uniform profile for improved print performance in a thermal label printer. The preferred label design has a layer of pressure sensitive adhesive applied over the inlay and beyond the edges of the inlay. Extending the adhesive layer beyond the inlay edges provides a smoother step transition, which eliminates printing voids along the inlay edges.

A first preferred method of applying the additional adhesive layer is to have the additional layer extend out beyond the perimeter edges of the inlay, thus masking the thickness transition of the inlay base film. This can be accomplished by applying an oversized adhesive patch to the release liner or directly on the label before laminating the liner to the label/inlay components.

A second preferred method applies a coat of adhesive only on the leading and trailing edges of the transponder. This provides improved printability characteristics of the RFID label; but does not increase the overall thickness of the label in the local area of the transponder.

A third preferred method is to use a low viscosity adhesive. The low viscosity adhesive is applied to the backside of the inlay prior to singulating the inlay and inserting it into the label stock. The adhesive flows beyond the perimeter of the transponder and fills the void between the label adhesive in the liner. The flow can either occur naturally, such as by gravity wind tension etc. or be forced by means of a nip roller. However, care must be taken to ensure that the adhesive flows sufficiently beyond the perimeter of the transponder. If there is not sufficient flow, the additional adhesive immediately under the inlay adds more thickness of the inlay. This results in a more pronounced up transition at the inlay edge which severely impacts printing.

A fourth preferred embodiment uses a low viscosity of adhesive on the label substrate that allows the transponder to compress into the adhesive layer.

To further reduce printer off out around the inlay parameter. The thickness of the transponder base film may also be minimized.

### BRIEF DESCRIPTION OF THE FIGURES

FIG. 1 is a printed prior art label.

FIG. 2 is a printed label using the inventive construction.

FIG. 3 is a label construction using the first preferred construction.

FIG. 4 is a label construction using the second preferred construction.

FIG. 5 is a label construction using the third preferred construction.

FIG. 6 is a label construction using an alternative construction.

FIG. 7 is a label construction using the fourth preferred construction.

### DETAILED DESCRIPTION OF THE INVENTION

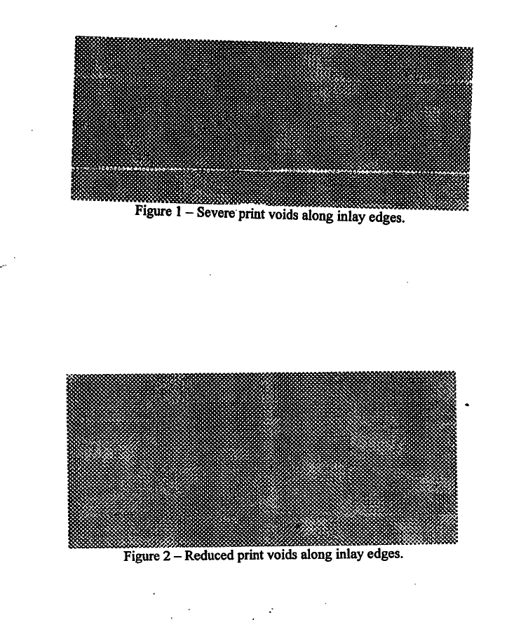

The inventive smart label construction provides a more uniform profile for improved print performance in a thermal label printer as shown in FIG. 2. Label 50 comprises label face stock 10, an adhesive layer 12 on adhesive face stock, an RFID insert 20 (also known as a chip, tag, transponder). Label 50 may be on release liner 16. The label construction has a layer of pressure sensitive adhesive 14 of applied over the inlay 20 and beyond the edges of the inlay 20. Extending adhesive layer 14 beyond inlay edges 20 provides a smoother step transition, which eliminates printing voids along inlay 20 edges.

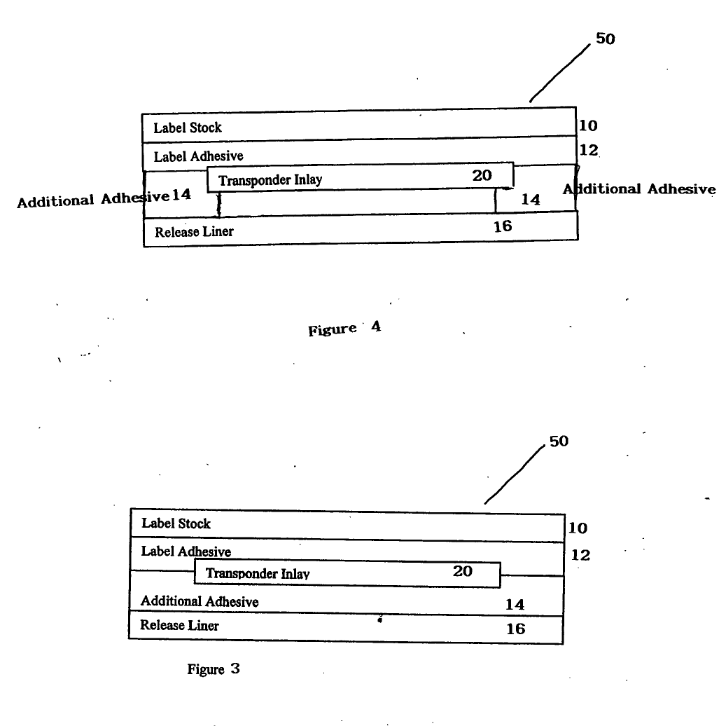

A first preferred method of applying additional adhesive layer 14 is to have additional adhesive layer 14 extend out beyond the perimeter edges of inlay 20, thus masking the thickness transition of the inlay 20 and base film 10 as shown in FIG. 3. This can be accomplished by applying an oversized adhesive patch to the release liner 16 or directly on the label stock/inlay before laminating liner 16 to the label stock/inlay components.

A second preferred method applies a coat of adhesive 14 only on the leading and trailing edges of the transponder 20 as shown in FIG. 4. This provides improved printability characteristics of the RFID label 50; but does not increase the overall thickness of label 50 in the local area of transponder 20.

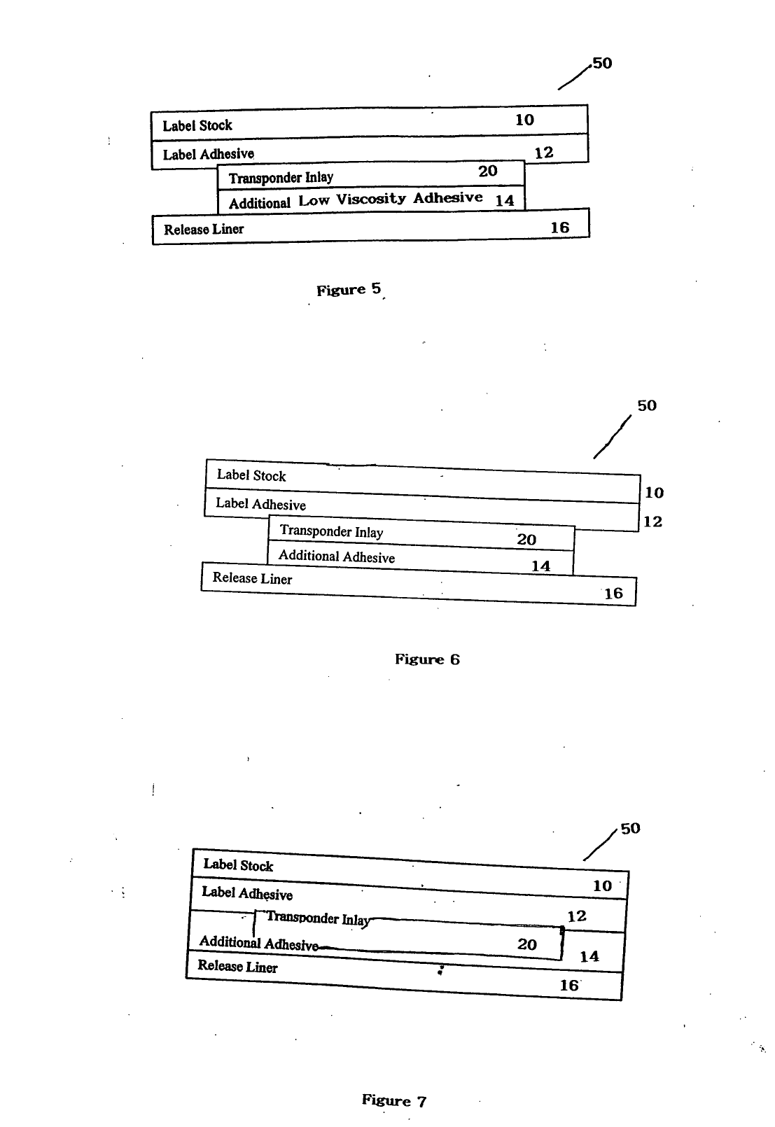

A third preferred method is to use a low viscosity adhesive 14. The low viscosity adhesive 14 is applied to the backside of the inlay 20 prior to singulating the inlay 20 and inserting it onto label stock 10. Adhesive flows 14 beyond the perimeter of transponder 20 and fills the void between label adhesive 12 and liner 16 as shown in FIG. 5. The flow can either occur naturally, such as by gravity, wind tension etc. or be forced by means of a nip roller. Care should be taken to ensure that the adhesive flows sufficiently beyond the perimeter of transponder 20. If there is not sufficient flow, the additional adhesive 14 immediately under inlay 20 adds more thickness to inlay portion of label 50. This results in a more pronounced transition at the inlay edge which severely impacts printing as shown in FIG. 6.

A fourth preferred embodiment uses low viscosity of adhesive 14 on label substrate 10 that allows transponder 20 to compress into the adhesive layer 12, 14 as shown in FIG. 7.

To further reduce printer voids around inlay 20 perimeter, thickness of the transponder base film may also be minimized.

1. A method of constructing a smart label comprising the steps of:
obtaining label stock having an adhesive layer and an RFID transponder on a first side,
applying an oversized adhesive patch at the RFID transponder,
allowing the adhesive patch to flow beyond the perimeter of the RFID transponder.

2. A method of constructing a smart label comprising the steps of:
obtaining label stock having an adhesive layer and an RFID transponder on a first side,
applying a coat of additional adhesive only on the leading and trailing edges of the transponder,
allowing the additional adhesive to flow beyond the perimeter of the RFID transponder.

3. A method of constructing a smart label comprising the steps of:
obtaining label stock having an adhesive layer;
applying a low viscosity to one side of an RFID transponder; and
applying the RFID transponder to the adhesive layer.

4. A method of constructing a smart label comprising the steps of:
obtaining label stock having a low viscosity adhesive layer; sinking the RFID transponder into the adhesive layer.
